(19) United States
(12) Patent Application Publication
(10) Pub. No.: US 2023/0347543 A1
(43) Pub. Date: Nov. 2, 2023

(54) DRAG KNIFE ATTACHMENT FOR CUTTING STENCILS AND METHOD OF USING SAME TO IMPART LETTER AND NUMBER TO THE FACE OF A STONE MONUMENT

(71) Applicant: Tong Li, Lansing, MI (US)

(72) Inventor: Tong Li, Haslett, MI (US)

(21) Appl. No.: 18/298,022

(22) Filed: Apr. 10, 2023

Related U.S. Application Data
(60) Provisional application No. 63/336,031, filed on Apr. 28, 2022.

(51) Int. Cl. B26D 7/26

(52) U.S. Cl. CPC B26D 7/2614; B26D 7/2628

(57) ABSTRACT

A drag knife apparatus for cutting stencil patterns in sheet material comprises a drag knife holder biased downwardly into cutting position by a variable tension spring and lifted out of cutting position by a relay-controlled solenoid. The knife holder is counterweighted through a lever arm. The apparatus can be used to form a sandblasting stencil from material adhesively held in position on the face of a monument during the stencil cutting process. The stencil is removed after the sandblasting step.

### CROSS-REFERENCE TO RELATED APPLICATIONS

This application claims in part the benefit of U.S. Provisional Application Ser. No. 63/336,031, filed on Apr. 28, 2022, the entire contents of which are incorporated herein by reference.

### BACKGROUND OF THE INVENTION

A drag knife is an apparatus used in combination with a CNC guidance system, to make stencils by cutting numbers, letters and other image elements from materials such as Vinyl, Mylar, plastic and other cuttable materials. It is necessary to lift the knife at the completion of one element so as to terminate the cutting before the knife is moved into position to begin cutting the next element. The knife blade is again lowered into the cutting position and moved in accordance with a program to form the next element of the stencil. This procedure is typically carried out using the combination of a spring which biases the drag knife and its holder toward the lifted position and a solenoid which acts in opposition to the spring to return the blade to the cutting position.

### SUMMARY OF THE INVENTION

In the present device, the roles played by the spring and solenoid are effectively reversed; i.e. the solenoid is used to lift the knife and its holder up out of the cutting position and the spring is used to urge the blade down into the cutting position. In accordance with an embodiment of the invention described in detail herein, the force imparted by the spring can be varied to change the force applied by it in accordance with Hooke's law. This accommodates different materials with different densities and resistances to being cut.

In addition, the embodiment here disclosed comprises a counterweight which effectively negates some or all of the weight of the knife and its holder so that the solenoid operates only to oppose the down force created by the spring. In the preferred embodiment hereinafter described, a lever arm is used in combination with the counterweight to effectively oppose or negate some or all the gravitational weight of the knife and its holder.

The knife and holder are essentially conventional in that the holder allows the knife blade to rotate about its own vertical axis to accommodate curves and turns in the outline of the stencils elements being cut. The illustrative invention and its operation can be expressed as the formula: F (down force)=knife and holder weight+spring force−lifting force of counterweight−lifting force of the solenoid. When the counterweight is equal to the mass/weight of the knife and holder and the solenoid is turned off, the down force equals the spring force. This formula can, of course, be varied by moving or changing the fulcrum or pivot point of the lever arm and/or changing its geometry to change the mechanical advantage created on the counterweight.

An advantageous method of using the apparatus is also described herein. The method can create a pattern in the face of a stone monument by sandblasting comprising the following steps: (a) adhesively joining a layer of cuttable material such as Vinyl or Mylar to the face of the stone where the pattern is to be formed; (b) placing the stone with the material in place in the cutting field of a numerically controlled drag knife system such as the apparatus described above; (c) operating the drag knife through the cutting field to cut the desired elements in the material; (d) removing the cut material from the elements to expose areas of the stone to form a stencil; (e) sandblasting the stone through the open areas of the formed stencil to impart the desired pattern to the stone; and thereafter; and (f) removing the adhesively attached stencil material from the stone.

### BRIEF DESCRIPTION OF THE DRAWINGS

FIG. 1 is a perspective view of a drag knife attachment illustrating the apparatus from one perspective;

FIG. 2 is another perspective drawing of the drag knife attachment from the opposite side showing the counterweight and the solenoid as well a relay for operating the drag knife;

FIG. 3 is a schematic side view of the embodiment of FIGS. 1 and 2 showing the lever arm and the various component for carrying out the invention;

FIG. 4 is diagrammatic view of the basic elements of the invention in a two-axis field wherein the drag knife is carried on a beam extending along and X—axis and the beam is in turn mounted for motion for and after long a double track Y—axis system;

FIG. 5 is a schematic diagram of the electrical circuit with switches used to operate the solenoid which lifts the drag knife out of contact with the material being cut; and

FIG. 6 is a diagram of the steps of the method of using the drag knife assembly.

### DETAILED DESCRIPTION OF THE APPARATUS AND METHOD USING SAME

Referring to the figures a substantially tubular drag knife holder 4 is attached to a clamp bracket 3 by means of a thumb screw adjuster 5 which in turn is connected to a bracket support 9 that is slidably mounted to an L shaped base plate 6 by means of a linear bearing 1 for a linear track 2 so that the drag knife holder 4 and the bracket assembly which holds it can slide vertically up and down under forces hereinafter described.

A tension spring 11 is connected by hook 10 between the bracket support plate 9 and a pin on the end of an adjustment arm 12 which in turn is connected to the base plate 6. The thumb screw force adjuster 13 can be used to allow adjustment of the angular position of the arm 12 and elongate the spring 11 to change the force produced by the spring pulling the drag knife holder 4 and the bracket 3 downwardly toward a medium to be cut.

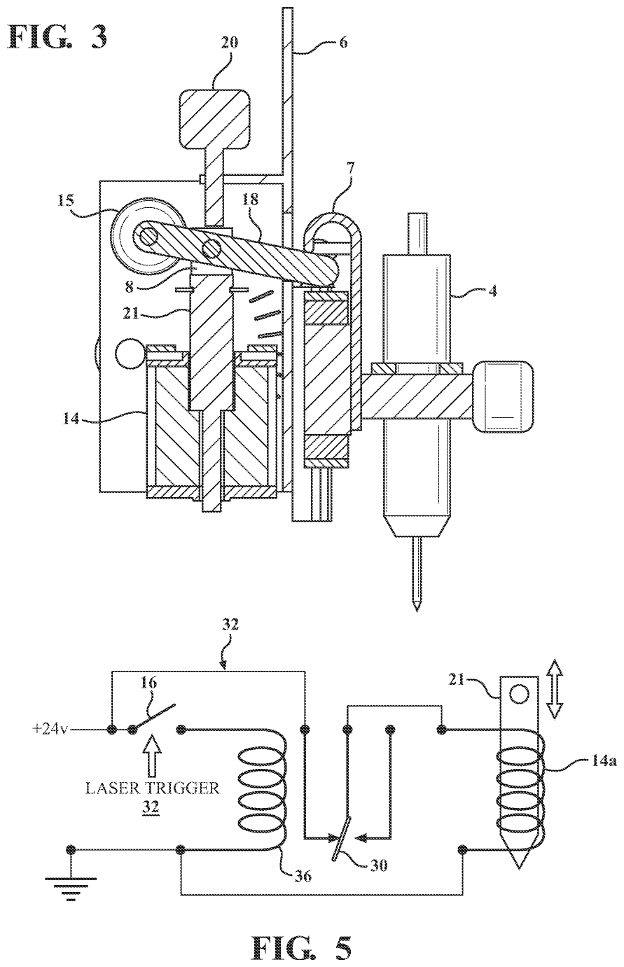

As further shown in the figures a solenoid 14 controlled by a relay 16 is mounted on the plate 6 and has an actuator assembly 17 oriented upwardly where it is pivotally joined to one end of a lever arm 18 by pin as best shown in FIG. 3. The lever arm 18 extends through an opening 8 in the base plate 6 and uses the bottom of the opening as a fulcrum. The right-hand end of the lever arm 18 as shown as in FIG. 3 is connected to apply a lifting force to the drag knife holder 4 and the assembly associated therewith. When the solenoid 14 is turned on, it pulls the left end of the lever arm down lifting the drag knife holder and associated assembly up and out of operating position where the blade carried by the holder is no longer and in contact with the medium to be cut.

In addition, a counterweight 15 is connected to the lefthand end of the lever arm 18 as shown in FIG. 3 such that the counterweight also imparts a lifting force to the knife holder 4 and the associate bracket. Ideally the weight of the counterweight equals the downforce produced by the combined weight of the knife holder and the associated bracket such that when the solenoid is turned off, the only force urging the drag knife, the drag knife holder and the associated slidable assembly downwardly toward the medium to be cut is the force created by the spring 11. In short, the downforce is a function of the aggregate weight of the knife holder urging it downwardly, the force produced by the counterweight 15 tending to lift the knife holder and negate the weight of it, the lifting action produced by the solenoid 14 which is turned off when a cutting action is desired, leaving the only downforce produced by the spring 11 which, as explained above, is adjustable by means of the lever arm and the thumb wheel 13 to change the length of the spring 11 thereby varying the net downforce produced by spring. Clearly the thumb screw 13 can be locked in place once the desired spring force has been achieved. The net downforce created by the spring, is, therefore variable to accommodate the various downforce on the drag knife produced by variation in the material being cut by the drag knife. Synthetic sheet materials such as Vinyl and Mylar require less downforce while heavier and more dense material such as wood and/or rigid plastics require more downforce on the drag knife as a result of the increased force necessary to move the knife in a cutting action through the material; i.e. cutting action in more dense materials tends to lift the knife as a natural result of the geometry of the cutting edge of the knife. This is a significant advantage of the present invention over the prior art where only the fixed downforce produced by a solenoid is used to hold the drag knife in position.

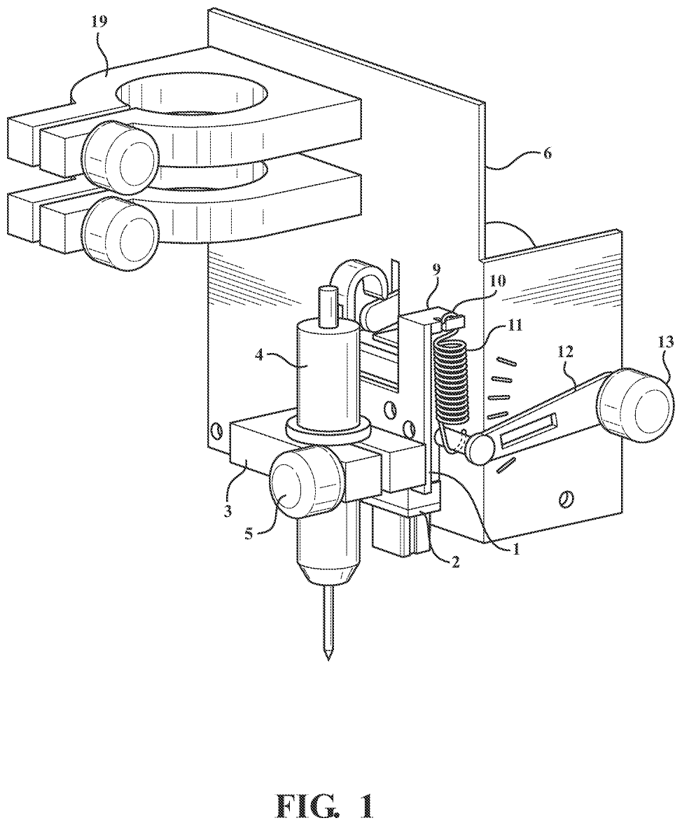

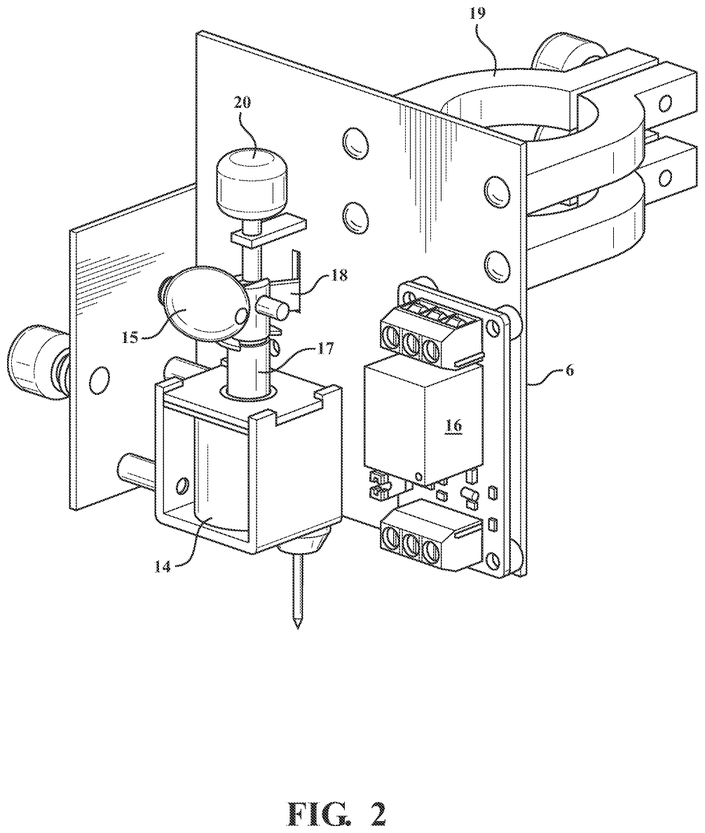

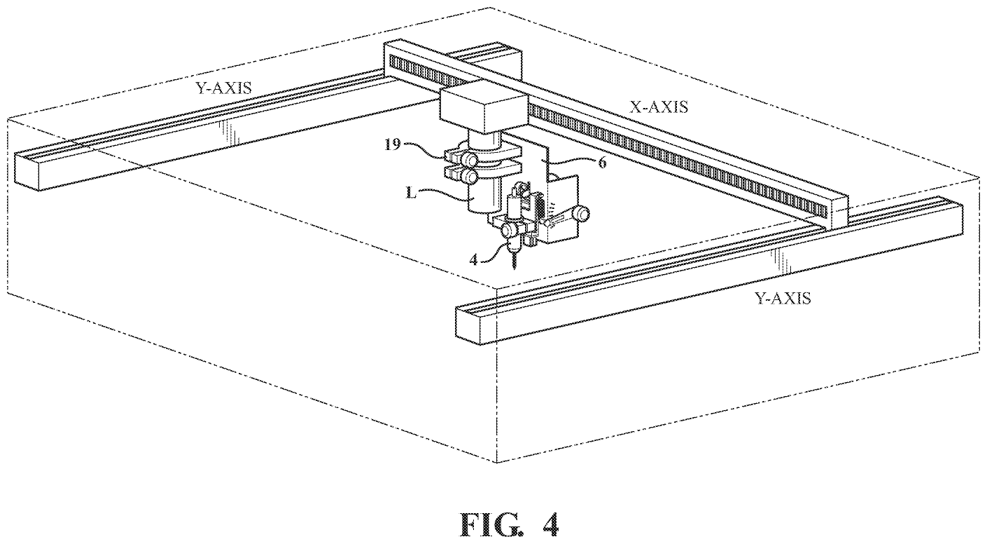

An advantage is provided by means of the bracket 19 which is connected to the base place 6 so as to allow the entire assembly shown in FIGS. 1-3 to be mounted on and in adjacent parallel relationship to a laser tube as shown in the diagrammatic of FIG. 4. The laser tube L shown in FIG. 4 is connected to a system for producing movement of the laser tube and the drag knife holder connected to it through an X-Y field of numerically controlled movement to cut the desired letters, numbers and other characters in the material being cut under the control of program which is normally used to control movement of laser tube in an engraving function. Details of the X-Y axis support system diagrammatically illustrated in FIG. 4 can be found in my issued U.S. Pat. No. 10,654,127, the entire disclosure of which is incorporated herein by reference.

By way of summary, the operation of the apparatus described above is essentially as follows: the assembly is attached to a laser tube in a numerical control laser engraving system by means of the bracket 19 with the drag knife holder oriented vertically; i.e. along the Z axis of the numerical control system. Once the drag knife is brought into the initial position where a cutting action is set to begin the solenoid 14 is turned off allowing the spring 11 to urge the drag knife vertically downwardly into contact with the material to be cut and the cutting action then ensues under control of the program in the laser engraving machine. Each time an element of a desire stencil pattern is finished, the solenoid is turned back on lifting the drag knife out of contact with the material. Thereafter the numerical control system moves the drag knife into position for the next element to be cut and the solenoid is turned off allowing the spring to urge the drag knife downwardly into operative engagement with the material to be cut. The laser is not operable during this process. The steps are repeated until the entire stencil is cut.

Referring to FIG. 5 the solenoid coil 14a is shown encircling the solenoid piston 21 and is connected through a switch 30 to a laser trigger circuit 32 including numerically control laser trigger switch 34 which applies a 24 volt signal to the coil 36 when it is desired to lift or lower the solenoid piston 21 during the engraving operation; i.e. as will be apparent from the foregoing, the solenoid remains in operation to periodically lift and lower the drag knife during a typical drag knife pattern cutting operation and this is preferable and advantageously carried out By means of the laser trigger circuit which is connected into the numerically controlled drag knife positioning system.

### Method of Imparting a Pattern to a Monument Stone

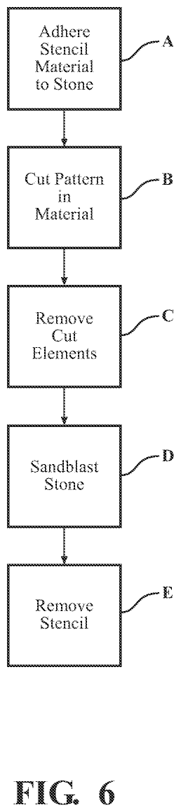

Referring now to FIG. 6 of the drawing a desired method of using the apparatus as described above is illustrated in FIG. 6. The first Step A is to adhere a suitable stencil material such as sheet Vinyl to the face of the stone which defines the field to which a pattern of numbers, letters and other elements is to be imparted by sandblasting. The material has an adhesive applied to the back surface so the material can be removably adhered to the face of the stone to covers the entire field to which a stencil pattern is to be cut,

Step B is the cutting of a desired pattern in the material adhered to the face of the stone suing the apparatus described above in combination with a numerically control laser engraving system. Again, the laser is inactive during this process.

Step C involves the manual removal of material from each of the fully cut elements in the stencil material to create opening for sandblasting material which is directed under power to the surface of the stone thought the now open stencil elements as shown in step C.

Step D is the removal of the stencil material from the face of the stone leaving the stone fully ready for use with the desire pattern imparted into the face of the stone by the sandblasting operation of Step D.

It is to be understood that the inventions have been described with respect to a preferred embodiment of the invention and that various changes and additions thereto may be made without departing from the spirit and scope of the invention as defined by the claims.

What is claimed is:

1. A drag knife cutter assembly for cutting stencil patterns in sheet material placed in a cutting field comprising:
a holder for a vertically oriented cutting blade;
means for mounting for said holder for vertical movement relative to the cutting field;
a solenoid selectively excitable to raise the holder relative to the cutting field;
a spring for urging the holder axially downwardly into the cutting field when the solenoid is excited; and
a counterweight operatively connected to the holder for negating the gravitational effect of the holder such that the spring provides at least the majority of down force on the holder when the solenoid is not excited.

2. A drag knife cutter assembly as defined in claim 1 further comprising means for adjusting the downward force exerted on the holder by the spring.

3. A drag knife cutter assembly as defined in claim 1 wherein the counterweight acts on the holder by way of a lever arm.

4. A drag knife cutter type cutter assembly as defined in claim 2 wherein the means for adjusting includes a mechanism for selectively varying the length of the spring such that the downward force exerted by the spring is governed by Hooke's Law.

5. A drag knife cutter assembly as defined in claim 1 wherein the holder is adapted to receive a cutting blade and allow rotation of the cutting blade about a vertical axis during a cutting operation.

6. A drag knife cutter assembly as defined in claim 1 further including a bracket for attaching the assembly to a numerically controlled laser.

7. A method of creating a pattern consisting at least in part of letters and numbers in the face of a stone monument by sandblasting comprising the steps of:
a) adhesively joining a layer of cuttable stencil material over the face of the stone;
b) placing the stone with the stencil material in place in the cutting field of a drag knife;
c) operating the drag knife through the cutting field to cut individual elements in the material;
d) removing the cut material from the elements to expose areas of the stone;
e) sandblasting the stone through the open areas to impart the desired pattern to the stone and, thereafter;
f) removing the remainder of the adhesively attached material from the stone.
